(19) United States
(12) Patent Application Publication
(10) Pub. No.: US 2026/0281000 A1
(43) Pub. Date: Sep. 17, 2026

(54) ELECTRONIC DEVICE AND METHOD FOR IDENTIFYING ANOMALY

(71) Applicants: Samsung Electronics Co., Ltd., Suwon-si (KR); POSTECH RESEARCH AND BUSINESS DEVELOPMENT FOUNDATION, Pohang-si (KR)

(72) Inventors: Seungho RYU, Suwon-si (KR); Sukhyun NAM, Pohang-si (KR); Taewoo KIM, Suwon-si (KR); Jaehyoung YOO, Pohang-si (KR); Jaegon KIM, Suwon-si (KR); Wonki HONG, Pohang-si (KR)

(21) Appl. No.: 19/666,859

(22) Filed: May 4, 2026

Related U.S. Application Data
(63) Continuation of application No. PCT/KR2024/013947, filed on Sep. 12, 2024.

(30) Foreign Application Priority Data
Nov. 6, 2023 (KR) 10-2023-0152228
Dec. 6, 2023 (KR) 10-2023-0175982

(51) Int. Cl. H04L 41/147; H04L 41/0695

(52) U.S. Cl. CPC H04L 41/147; H04L 41/0695

(57) ABSTRACT

An electronic device is provided. The electronic device includes memory, comprising one or more storage media, storing instructions, and at least one processor comprising processing circuitry. The instructions, when executed by the at least one processor individually or collectively, cause the electronic device to obtain, rom at least one network element (NE), log data related to an operation of at least one NE, based on the log data, obtain, through a designated algorithm, a log pattern, based on the log pattern, identify first state information and second state information, identify that the second state information is distinct from state information identified through at least one model using the first state information, and based on identifying that the second state information is distinct from the state information identified through the at least one model, identify an anomaly in the at least one NE.

### CROSS-REFERENCE TO RELATED APPLICATION(S)

This application is a continuation application, claiming priority under 35 U.S.C. § 365 (c), of an International application No. PCT/KR2024/013947, filed on Sep. 12, 2024, which is based on and claims the benefit of a Korean patent application number 10-2023-0152228, filed on Nov. 6, 2023, in the Ministry of Intellectual Property (MOIP), and of a Korean patent application number 10-2023-0175982, filed on Dec. 6, 2023, in the MOIP, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., LTD., and 2) Postech Research and Business Development Foundation.

### BACKGROUND

### 1. Field

The disclosure relates to an electronic device and a method for identifying an anomaly.

### 2. Description of Related Art

A key performance indicator (KPI) may be defined to indicate quality of a network. A wireless communication system may determine whether an anomaly of a network has occurred through a value related to the KPI. As the value related to the KPI is managed in the wireless communication system, the quality of the network may be improved.

The above information is presented as background information only to assist with an understanding of the disclosure. No determination has been made, and no assertion is made, as to whether any of the above might be applicable as a prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for identifying an anomaly.

Additional aspects will be set forth in part in the description which follows and, in part, will be apparent from the description, or may be learned by practice of the presented embodiments.

In accordance with an aspect of the disclosure, an electronic device is provided. The electronic device includes memory, comprising one or more storage media, storing instructions, and at least one processor comprising processing circuitry. The instructions, when executed by the at least one processor individually or collectively, cause the electronic device to obtain, from at least one network element (NE), log data related to an operation of the at least one NE. The instructions, when executed by the at least one processor individually or collectively, cause the electronic device to, based on the log data, obtain, through a designated algorithm, a log pattern. The instructions, when executed by the at least one processor individually or collectively, cause the electronic device to, based on the log pattern, identify first state information and second state information. The instructions, when executed by the at least one processor individually or collectively, cause the electronic device to identify that the second state information is distinct from state information identified through at least one model using the first state information. The instructions, when executed by the at least one processor individually or collectively, cause the electronic device to, based on identifying that the second state information is distinct from the state information identified through the at least one model, identify an anomaly of the at least one NE.

In accordance with another aspect of the disclosure, a method performed by an electronic device is provided. The method includes obtaining, from at least one network element (NE), log data related to an operation of the at least one NE. The method includes, based on the log data, obtaining, through a designated algorithm, a log pattern. The method includes, based on the log pattern, identifying first state information and second state information. The method includes identifying that the second state information is distinct from state information identified through at least one model using the first state information. The method includes, based on identifying that the second state information is distinct from the state information identified through the at least one model, identifying an anomaly of the at least one NE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a system including an electronic device for obtaining log data related to an operation of a network element (NE) according to an embodiment of the disclosure;

FIG. 3 illustrates an example of a software defined network (SDN) architecture according to an embodiment of the disclosure;

FIG. 4 illustrates a configuration of an anomaly detector according to an embodiment of the disclosure;

FIG. 5 illustrates a flowchart related to an operation of an anomaly detector according to an embodiment of the disclosure;

FIG. 6 illustrates an example of an operation of a log parser according to an embodiment of the disclosure;

FIG. 7 illustrates an example of an operation of a state model according to an embodiment of the disclosure;

FIG. 8 illustrates an example of an operation of a prediction model according to an embodiment of the disclosure;

FIG. 9 illustrates a flowchart related to an operation of an anomaly detector according to an embodiment of the disclosure; and

FIG. 10 illustrates an example of a functional configuration of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to a signal (e.g., a signal, information, symbol, a message, signaling, a reference signal (RS), or data), a term referring to a resource (e.g., a symbol, a slot, a subframe, a radio frame, a subcarrier, a resource element (RE), a resource block (RB), a bandwidth part (BWP), or an occasion), a term for a computation state (e.g., a step, an operation, or a procedure), a term referring to data (e.g., a packet, a user stream, information, a bit, a symbol, or a codeword), a term referring to a channel, a term referring to network entities, a term referring to a component of a device, and the like used in the following descriptions are exemplified for convenience of description. Therefore, the disclosure is not limited to terms described below, and another term having an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {′C′, ‘D’, and ‘C’ and ‘D’}.

Although the disclosure describes various embodiments using terms used in some communication standards (e.g., 3rd Generation Partnership Project (3GPP), extensible radio access network (xRAN), open-radio access network (O-RAN)), these are only examples for explanation. The various embodiments of the disclosure may be easily modified and applied to other communication systems.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

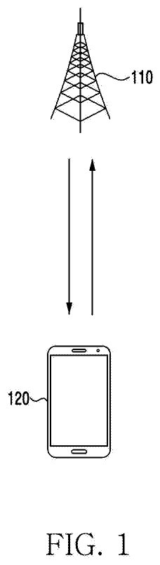

FIG. 1 illustrates a wireless communication system according to an embodiment of the disclosure.

Referring to FIG. 1, illustrates a base station 110 and a terminal 120 as a portion of nodes that utilize a wireless channel in a wireless communication system. FIG. 1 illustrates only one base station, but a wireless communication system may further include another base station that is identical or similar to the base station 110.

The base station 110 is a network infrastructure that provides wireless access to the terminal 120. The base station 110 has coverage defined based on a distance at which a signal may be transmitted. In addition to ‘base station’, the base station 110 may be referred to as an ‘access point (AP)’, ‘eNodeB (eNB)’, ‘5th generation node’, ‘next generation nodeB (gNB)’, ‘wireless point’, ‘transmission/reception point (TRP)’ or other terms having equivalent technical meanings.

The terminal 120, which is a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication with each other through a wireless channel. At this time, a link (device-to-device link (D2D)) between the terminal 120 and the other terminal is referred to as a sidelink, and the sidelink may be used interchangeably with a PC5 interface. In some other embodiments, the terminal 120 may be operated without the user's involvement. According to an embodiment, the terminal 120, which is a device performing machine type communication (MTC), may not be carried by the user. Additionally, according to an embodiment, the terminal 120 may be a narrowband (NB)-internet of things (IOT) device.

In addition to ‘terminal’, the terminal 120 may also be referred to as ‘user equipment (UE)’, ‘customer premises equipment, (CPE)’, ‘mobile station’, ‘subscriber station’, ‘remote terminal’, ‘wireless terminal’, ‘electronic device’, ‘user device’, or other terms having equivalent technical meanings.

As a web-based service increases, a scale of a network may increase, and complexity of a network configuration may increase. As the complexity of the network configuration increases, various problems including failure, breakdown, packet loss, and/or increase in latency may occur. In order to solve these problems, before a critical failure for network elements (NEs) (or network equipments) configuring the network occurs, a method for identifying an anomaly of the NEs may be required.

In order to identify an anomaly for the NEs, a state of the network should be monitored in real time based on at least one of resource usage of the NEs and systems related to the NEs, state information of the NEs and the systems related to the NEs, network traffic information, and/or log data. Monitoring the network state and/or a state of the NEs in real time may require many human resources and material resources. Therefore, in the following specification, a technical feature for identifying an anomaly related to an operation of the NEs, based on log data output from the NEs (or log data obtained from the NEs) will be described.

According to an embodiment, log data may represent a state of an NE (or a network equipment). However, the log data may be configured with text data in different formats according to a manufacturer (or a developer) of the NE (or the network equipment). For example, the log data may be configured with unstructured data. Therefore, an operation of an electronic device for analyzing log data by using natural language processing (NLP) based on artificial intelligence will be described below.

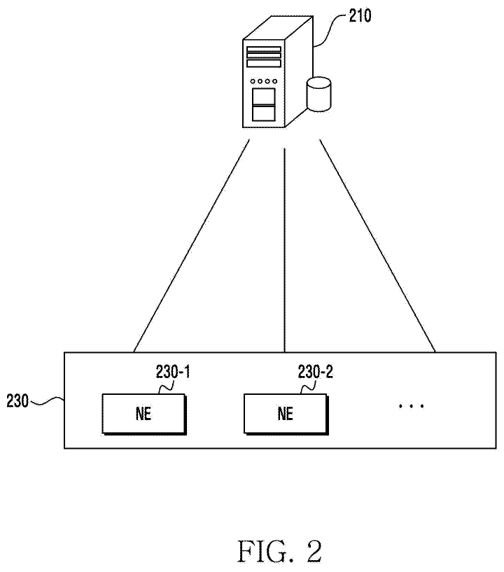

FIG. 2 illustrates a system including an electronic device for obtaining log data related to an operation of a network element (NE) according to an embodiment of the disclosure.

Referring to FIG. 2, an electronic device 210 may be used to obtain log data related to an operation of a plurality of network elements (NEs) 230. For example, the plurality of NEs 230 may include an NE 230-1 and an NE 230-2. For example, the plurality of NEs 230 may include a router, a distributed unit (DU), and/or a radio unit (RU). For example, an NE may be referred to as a network device.

Each of the plurality of NEs 230 may generate log data for an operation. Each of the plurality of NEs 230 may transmit the log data for the operation to the electronic device 210. For example, the electronic device 210 may receive log data generated based on various formats. The electronic device 210 may monitor the log data. The electronic device 210 may identify (or determine) an anomaly for the plurality of NEs 230, based on monitoring the log data.

Hereinafter, an anomaly may be referred to as an abnormal state. For example, identifying an anomaly of an NE may be referred to as identifying an NE in an abnormal state.

According to an embodiment, the electronic device 210 may obtain data collected through a sensor of an NE (e.g., the NE 230-1 and/or the NE 230-2), or data output from the NE or the electronic device 210. The obtained data may be configured in a format of a specific value. Information on a normal range and an abnormal range of the obtained data may be in a state of being stored in memory of the electronic device 210. The electronic device 210 may identify or determine whether the NE is in an anomaly, based on the obtained data.

According to an embodiment, the electronic device 210 may obtain unstructured data related to an operation of an NE. The unstructured data may not be in a format of a specific value. The electronic device 210 may process the obtained unstructured data. The electronic device 210 may identify (or determine) an anomaly of the NE, based on the processed data. For example, the electronic device 210 may identify the anomaly of the NE based on the unstructured data by using at least one of two techniques. According to a first technique, the electronic device 210 may identify the anomaly of the NE based on a result for a specific task (or operation) of the NE. According to a second technique, the electronic device 210 may identify the anomaly of the NE based on log data related to an operation of the NE. The second technique may operate in a rule-based manner. According to the second technique, an alarm may be generated based on generation of a specific log.

According to the first technique, the electronic device 210 may identify the anomaly of the NE based on the result for the specific task (or operation) of the NE. The result for the specific task (or operation) of the NE may be classified into one of a plurality of categories. Therefore, the electronic device 210 may determine the anomaly of the NE, based on determining whether the result for the specific task (or operation) of the NE is included in one of the plurality of categories. The electronic device 210 may determine the anomaly of the NE, based on determining whether a result for tasks (or operations) sequentially performed is included in one of the plurality of categories.

According to the second technique, the electronic device 210 may identify the anomaly of the NE based on the log data related to the operation of the NE. The log data may be configured with unstructured data. The log data may include text representing information that a manufacturer (or developer or user) for the NE determines that an output is needed. According to a manufacturer (or developer or user) or a type of the NE, the log data may be configured in a different format. Therefore, in a case that log data indicating an error includes designated content, the electronic device 210 may identify that the NE is in an abnormal state (or the anomaly of the NE). According to an embodiment, the electronic device 210 may identify (or extract) a common portion in the log data as a log key. The electronic device 210 may analyze a meaning of the log data based on the log key. The electronic device 210 may determine whether the NE is in the abnormal state according to the meaning of the log data. According to an embodiment, the electronic device 210 may train a designated model (e.g., an artificial intelligence model) through a normal log pattern identified by using log data arranged in chronological order. The electronic device 210 may set the log data as input data of the designated model. The electronic device 210 may determine whether the NE is in the abnormal state based on output data of the designated model. However, according to the second technique, since a repeated word is set as the log key, a meaning of the repeated word may not be considered. Therefore, content of actual log data may not be reflected.

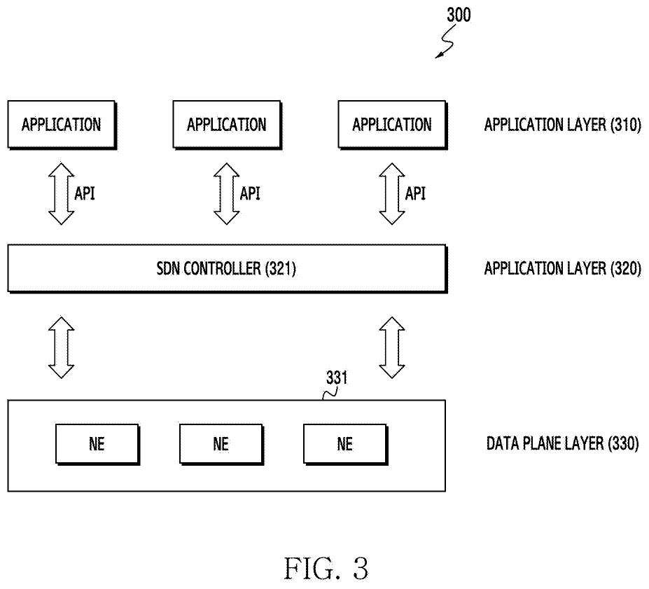

Hereinafter, in a network configured based on a software defined network (SDN), a technical feature for identifying anomaly of an NE by using at least one model (e.g., an artificial intelligence model) will be described. First, an SDN architecture will be described in FIG. 3.

FIG. 3 illustrates an example of a software defined network (SDN) architecture according to an embodiment of the disclosure.

Referring to FIG. 3, an SDN 300 may include an application layer 310, a control plane layer 320, and/or a data plane layer 330.

The application layer 310 may include one or more applications used for a control operation including routing and/or load balance. An application may exclusively control a resource set exposed by an SDN controller. The application may invoke another application or collaborate with another application.

The control plane layer 320 may include an SDN controller 321. The SDN controller 321 may be used for control of overall network resources. The SDN controller 321 may obtain network information and provide the obtained information to an application.

The data plane layer 330 may include at least one NE 331. The at least one NE 331 may include at least one physical switch and/or at least one virtual switch.

An interface between the control plane layer 320 and the application layer 310 may be referred to as a northbound application programming interface (API). An interface between the control plane layer 320 and the data plane layer 330 may be referred to as a southbound API. For example, between the control plane layer 320 and the data plane layer 330, an openflow protocol or an OpFlex protocol may be used.

While existing NEs (or network equipments) operate independently based on a data plane and a control plane, a data plane and a control plane of an NE may be separated in the SDN 300. The SDN controller 321 may perform an operation of the control plane of the NE. The SDN 300 may operate based on an algorithm for network control. Therefore, in the SDN 300, a network may be managed and controlled based on a designated algorithm even without intervention of an administrator. In addition, at least one NE 331 configuring a network may be managed through the SDN controller 321. In order to operate in conjunction with the SDN controller 321, the at least one NE 331 may support at least one of a representational state transfer protocol (REST), a network configuration protocol (NETCONF), or a representational state transfer configuration protocol (RESTCONF). The SDN controller 321 may control the at least one NE 331 by using at least one of the REST, the NETCONF, or the RESTCONF.

Hereinafter, in the SDN 300, a technical feature for performing network management by using artificial intelligence will be described. For example, by using network information (e.g., log data) obtained through the SDN controller 321, a network may be analyzed through an artificial intelligence model, and in a case that a problem occurs, the occurred problem may be solved through the artificial intelligence model. For example, in the SDN 300, an anomaly of an NE may be monitored by using an artificial intelligence model. In a case that the anomaly of the NE is found, the SDN controller 321 may isolate the corresponding NE and control network traffic to be transmitted through another NE.

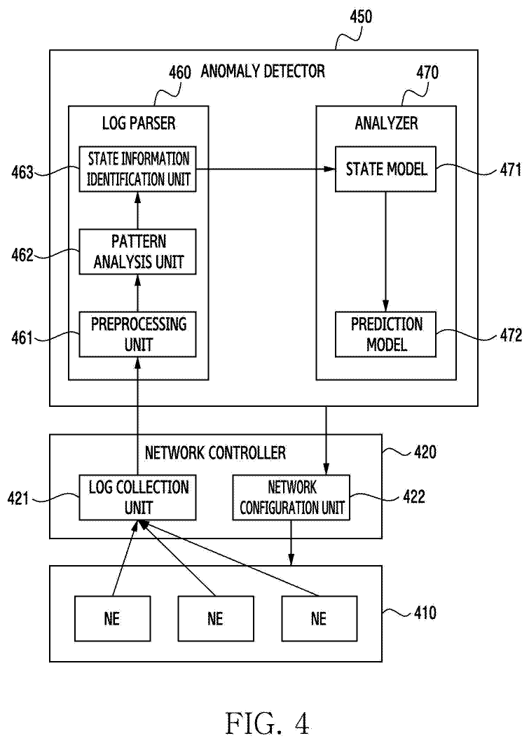

FIG. 4 illustrates a configuration of an anomaly detector according to an embodiment of the disclosure. Hereinafter, terms such as “ . . . unit”, “ . . . er”, and the like used below may mean a unit processing at least one function or operation, and which may be implemented by hardware, software, or a combination of hardware and software.

Referring to FIG. 4, at least one NE 410 may transmit log data to a network controller 420. The network controller 420 may receive the log data from the at least one NE 410. For example, the network controller 420 may correspond to the SDN controller 321 of FIG. 3.

The network controller 420 may include a log collection unit 421 and a network configuration unit 422. The log collection unit 421 may be configured to receive log data from the at least one NE 410 and to transmit the received log data to an anomaly detector 450. The network configuration unit 422 may be configured to change a setting of the at least one NE 410, or to control an operation of the at least one NE 410.

The anomaly detector 450 may include a log parser 460 and an analyzer 470. Log data collected from the at least one NE 410 may be delivered to the log parser 460 through the network controller 420.

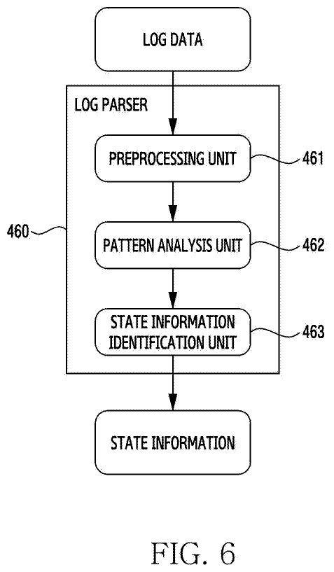

The log parser 460 may include at least one of a preprocessing unit 461, a pattern analysis unit 462, and/or a state information identification unit 463. The preprocessing unit 461 may be used for preprocessing log data. The pattern analysis unit 462 may be used to obtain (or identify) a log pattern based on log data. The state information identification unit 463 may be used to identify state information based on the log pattern. For example, the state information may include an event number related to log data. The state information identification unit 463 may be referred to as an event classification unit. A specific operation of the log parser 460 will be described later in FIG. 6.

The analyzer 470 may receive state information from the log parser 460. The analyzer 470 may identify an anomaly of the at least one NE 410 based on the state information. The analyzer 470 may include at least one of a state model 471 and/or a prediction model 472.

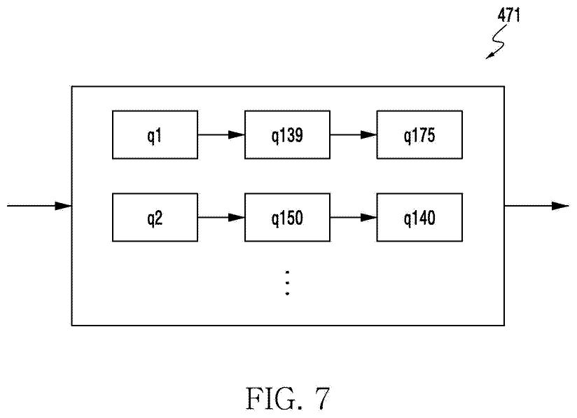

The state model 471 may be used to identify the anomaly of the at least one NE 410 based on a state change for a log pattern. The state model 471 may be configured based on a finite state automata. A specific operation of the state model 471 will be described later in FIG. 7.

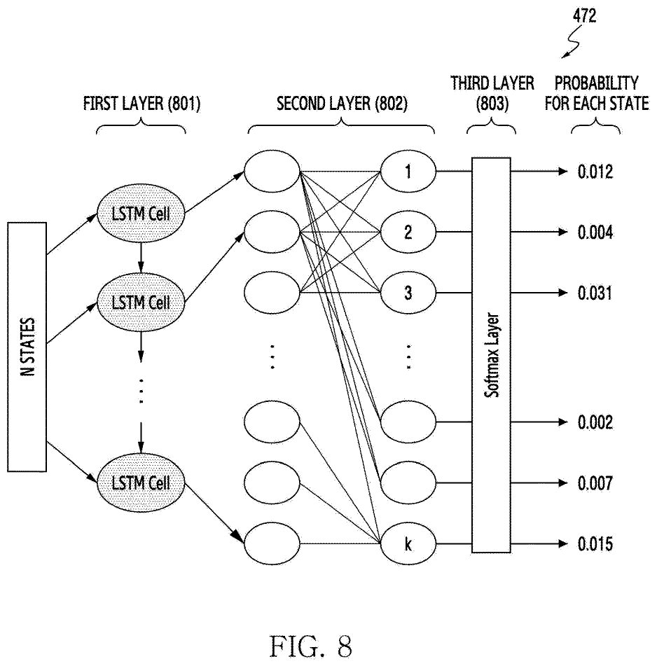

The prediction model 472 may be used to identify the anomaly of the at least one NE 410 based on a predicted state for a log pattern. The prediction model 472 may be configured based on a long short term memory (LSTM). A specific operation of the prediction model 472 will be described later in FIG. 8.

According to an embodiment, the anomaly detector 450 may identify the anomaly of the at least one NE 410 through three steps.

In a first step, the anomaly detector 450 may identify whether the at least one NE 410 is in an abnormal state, based on identifying whether a log pattern obtained based on log data by using the log parser 460 corresponds to one of a plurality of log patterns representing a normal state. The anomaly detector 450 (or the network controller 420) may provide a notification (or an alarm), based on identifying the anomaly of the at least one NE 410 through the first step. The anomaly detector 450 may perform a second step, based on identifying that the at least one NE 410 is not in the anomaly through the first step.

In the second step, the anomaly detector 450 may identify whether the at least one NE 410 is in the abnormal state, based on identifying whether state information obtained by using the log parser 460 corresponds to state information obtained by using the state model 471. The anomaly detector 450 (or the network controller 420) may provide a notification (or an alarm), based on identifying the anomaly of the at least one NE 410 through the second step. The anomaly detector 450 may perform a third step, based on identifying that the at least one NE 410 is not in the anomaly through the second step.

In the third step, the anomaly detector 450 may identify whether the at least one NE 410 is in the abnormal state, based on identifying whether the state information obtained by using the log parser 460 corresponds to state information obtained by using the prediction model 472. The anomaly detector 450 (or the network controller 420) may provide a notification (or an alarm), based on identifying the anomaly of the at least one NE 410 through the third step.

According to an embodiment, the network controller 420 may change a path of data traffic to bypass an NE in which an anomaly has occurred, based on identifying the anomaly of the at least one NE 410.

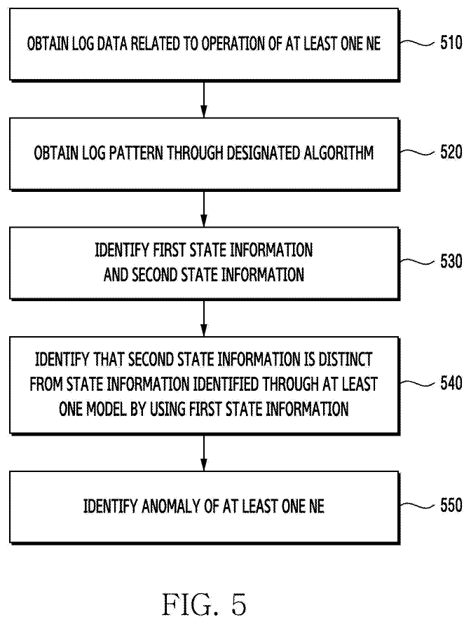

FIG. 5 illustrates a flowchart related to an operation of an anomaly detector according to an embodiment of the disclosure.

Referring to FIG. 5, in operation 510, an anomaly detector 450 (or an electronic device for the anomaly detector 450) may obtain log data related to an operation of at least one NE 410. For example, the anomaly detector 450 may obtain, through a network controller 420, the log data related to the operation of the at least one NE 410. The anomaly detector 450 may monitor the log data related to the operation of the at least one NE 410.

In operation 520, the anomaly detector 450 may obtain a log pattern through a designated algorithm. For example, the anomaly detector 450 may obtain the log pattern through the designated algorithm based on log data. For example, the anomaly detector 450 may obtain the log pattern by using a log parser 460.

For example, the anomaly detector 450 may normalize log data based on a designated algorithm. The anomaly detector 450 may normalize the log data in order to identify state information through the log data. The anomaly detector 450 may remove unnecessary information from the log data through the designated algorithm. The anomaly detector 450 may normalize the log data by removing the unnecessary information from the log data. The anomaly detector 450 may obtain the log pattern based on normalizing the log data. The anomaly detector 450 may obtain the log pattern in order to identify the state information.

In operation 530, the anomaly detector 450 may identify first state information and second state information. For example, the anomaly detector 450 may identify the first state information and the second state information based on the log pattern. For example, the log data may include log messages (text) obtained within a designated time interval. The first state information may represent a state related to the at least one NE 410 at a first time point. The second state information may represent a state related to the at least one NE 410 at a second time point after the first time point. For example, the first state information may represent a past state of the at least one NE 410. The second state information may represent a current state of the at least one NE 410. For example, the first state information may include a first event number. The second state information may include a second event number. Each of the first event number and the second event number may be a value for indicating a state of the at least one NE 410.

According to an embodiment, the anomaly detector 450 may identify whether the log pattern corresponds to one of a plurality of log patterns stored in memory. The plurality of log patterns stored in the memory may represent a normal state. In a case that the log pattern corresponds to one of the plurality of log patterns stored in the memory, the anomaly detector 450 may identify the first state information and the second state information based on the log pattern. In a case that the log pattern does not correspond to one of the plurality of log patterns stored in the memory, the anomaly detector 450 may identify an anomaly of the at least one NE 410.

In operation 540, the anomaly detector 450 may identify that the second state information is distinct from state information identified through at least one model by using the first state information.

In operation 550, the anomaly detector 450 may identify the anomaly of the at least one NE 410. For example, the anomaly detector 450 may identify the anomaly of the at least one NE 410 based on identifying that the second state information is distinct from the state information identified through the at least one model by using the first state information.

For example, the anomaly detector 450 may identify the state information through the at least one model by using the first state information. The anomaly detector 450 may identify the state information through the at least one model by using the first state information representing the past state. The anomaly detector 450 may identify the anomaly of the at least one NE 410 based on identifying that the identified state information is distinct from the second state information.

According to an embodiment, the at least one model may include a state model 471 and a prediction model 472.

For example, the anomaly detector 450 may identify third state information through the state model 471. The anomaly detector 450 may input the first state information to the state model 471. The anomaly detector 450 may set input data of the state model 471 as the first state information. The anomaly detector 450 may obtain the third state information based on an output of the state model 471. For example, the state model 471 may identify, as the third state information, state information that may be changed (or transitioned) from the first state information in a normal state. The anomaly detector 450 may identify the anomaly of the at least one NE 410 based on identifying that the second state information is not the state information that may be changed from the first state information.

For example, the anomaly detector 450 may identify fourth state information through the prediction model 472. The anomaly detector 450 may input the first state information to the prediction model 472. The anomaly detector 450 may set input data of the prediction model 472 as the first state information. The anomaly detector 450 may obtain the fourth state information based on an output of the prediction model 472. For example, the prediction model 472 may identify, as the fourth state information, state information predicted to be changed from the first state information in a normal state. As an example, the anomaly detector 450 may identify probability data on each of a plurality of states based on the output of the prediction model 472. The anomaly detector 450 may obtain the fourth state information based on a state having the highest probability among the plurality of states.

The anomaly detector 450 may identify the anomaly of the at least one NE 410 based on identifying that the second state information is not the fourth state information representing a predicted state.

FIG. 6 illustrates an example of an operation of a log parser according to an embodiment of the disclosure.

Referring to FIG. 6, an anomaly detector 450 may process log data obtained from at least one NE 410 by using a log parser 460. For example, the log parser 460 may include at least one of a preprocessing unit 461, a pattern analysis unit 462, and/or a state information identification unit 463. The anomaly detector 450 may perform a preprocessing operation, a pattern analysis operation, and a state information identification operation by using the log parser 460. The anomaly detector 450 may change the log data to a log pattern through the log parser 460. The anomaly detector 450 may identify whether the log pattern corresponds to one of a plurality of log patterns stored in memory. The plurality of log patterns stored in the memory may represent a normal state. The anomaly detector 450 may provide a notification (or an alarm) based on identifying that the log pattern does not correspond to one of the plurality of log patterns stored in the memory.

For example, the anomaly detector 450 may perform the preprocessing operation by using the preprocessing unit 461 of the log parser 460. The anomaly detector 450 may normalize the log data by using the preprocessing unit 461.

As an example, the preprocessing unit 461 may change an uppercase letter of log content according to the log data to a lowercase letter. The preprocessing unit 461 may remove at least one of a number, a date, a file path, a location name, an interface name, and/or a symbol among the log content according to a designated rule. Some of removed words may be replaced with a token having a meaning. For example, some of words included in the log content may be changed as shown in the table below.

TABLE 1

| Log content | Example | Token |
|---|---|---|
| Number | 1, 2, 3, . . . | [number] |
| Base-N | Binary, Hexadecimal | [number] |
| Date | Year, May, Monday, Friday | [date] |
| Location | ‘Jincheon’, ‘Hyehwa’ | [loc] |
| File path | /dic, /recent | [path] |
| Interface | HundGi0/3 | [interface] |

Referring to Table 1, some of words included in the log content may be replaced with a token based on a rule as shown in Table 1. For example, the number (or East Arabic numerals) included in the log content may be replaced with the [number] token. A value of radix n may be converted based on a regular expression, and the converted number may be replaced with the [number] token. The date and the location name may be removed through a dictionary obtained through training data. As an example, the date may be replaced with the [date] token. The location name may be replaced with the [loc] token. Since a Linux-based file path starts with ‘/’, a word starting with ‘/’ may be replaced with the [path] token. Since a name of the interface follows the word ‘interface’, a word immediately following the word ‘interface’ may be changed to the [interface] token.

The preprocessing operation through the preprocessing unit 461 of the log parser 460 may be completed by removing all symbols that are not changed to the token. The preprocessing operation may be performed based on the designated rule as shown in Table 1. Therefore, a user (or an administrator) may change the preprocessing operation by changing a rule according to actual log data.

For example, the anomaly detector 450 may perform the pattern analysis operation by using the pattern analysis unit 462 of the log parser 460. The anomaly detector 450 may perform the pattern analysis operation through the pattern analysis unit 462 of the log parser 460 after the preprocessing operation is performed.

As an example, the pattern analysis unit 462 may identify (or analyze) a log pattern based on a word dictionary. The word dictionary may be generated in advance through log data in a normal state. The word dictionary may be generated with words appearing the designated number of times (e.g., 3 times) or more in training data (e.g., log data) after the preprocessing operation is performed. Since the word dictionary is generated with the words appearing the designated number of times (e.g., 3 times) or more, a temporarily generated word such as a process identifier (ID) may be removed. The designated number of times may be changed according to setting information on the pattern analysis unit 462.

A word that is not in the word dictionary among log content obtained after the preprocessing operation is performed may be changed to an [UNK] (unknown) token. After the pattern analysis operation is performed, log data may be changed (or compressed) to a log pattern of substantially the same form. In a case that the log content (or log message) is configured as ‘Interface HundGi0/3, changed state to FREQ_LOCK’, after the preprocessing operation and the pattern analysis operation are performed, the log content (or log message) may be changed to a log pattern configured as ‘interface [interface] changed state to freq lock’. At this time, only the interface name may be changed to the [interface] token. According to the above-described example, log content (or log message) related to the same operation even in a case that an interface is different may be represented as one log pattern.

For example, the anomaly detector 450 may perform the state information identification operation by using the state information identification unit 463 of the log parser 460. The anomaly detector 450 may perform the state information identification operation through the state information identification unit 463 of the log parser 460 after the pattern analysis is performed.

The state information identification unit 463 may identify (or obtain) state information based on a log pattern. The state information may include an event number. The event number may be a value for indicating a state of the at least one NE 410. In that the event number is identified (or obtained) through the state information identification unit 463, the state information identification unit 463 may be referred to as an event classification unit.

The state information identification unit 463 may identify state information (e.g., an event number) based on a log pattern. Based on the state information identification operation, the same or similar log patterns may be identified (or classified) as the same state information (e.g., event number). Log patterns obtained based on training data may be registered in a state dictionary through the state information identification operation. A log pattern list according to each state information may be stored in the memory.

An operation for configuring the state dictionary may be performed based on a minimum edit distance algorithm. The minimum edit distance algorithm may be an algorithm for measuring similarity of two sentences. A ‘word removal’ operation, a ‘word addition’ operation, and a ‘word conversion’ operation may each be defined as one modification. Similarity of the two sentences may be measured through the minimum number of modifications for the two sentences to become the same.

According to the minimum edit distance algorithm, a cost may be defined. For example, by using a synonym and antonym dictionary, in a case that a relation between an existing word and a converted word is a synonym according to the ‘word conversion’ operation, the cost may be set as a first cost (e.g., ‘0’). By using the synonym and antonym dictionary, in a case that a relation between the existing word and the converted word is an antonym according to the ‘word conversion’ operation, the cost may be set as a second cost (e.g., ‘6’). According to an embodiment, the first cost and the second cost may be changed. For example, the first cost and the second cost may be changed by an administrator (or a user).

In a case that two log patterns have meanings opposite to each other, an antonym dictionary may be used in order to further increase the cost for the ‘word conversion’ operation. In a case that meanings of two log patterns are opposite to each other, such as ‘interface up’ and ‘interface down’, since the minimum edit distance is small but actual meanings are opposite, the two log patterns should be identified as different state information. Therefore, the state information identification unit 463 may identify the two log patterns having opposite meanings as different state information by increasing the cost for the ‘word conversion’ operation by using the antonym dictionary. According to an embodiment, the antonym dictionary may utilize a public antonym dictionary such as WordNet.

Based on the above-described minimum edit distance algorithm, in a case that a cost for two log patterns to become the same is less than half of an average of lengths of the two log patterns, the two log patterns may become the same as half or less of the two log patterns are modified. Therefore, the two log patterns may be identified (or classified) as the same state information (e.g., event number). A reason that half of the average of the lengths of the two log patterns is set as a reference as in the above-described example is to prevent a problem in which short log patterns may always be identified as the same state information regardless of meanings in a case that a certain threshold is set as the reference.

Through the above-described example, based on the minimum edit distance algorithm, each of a plurality of log patterns obtained (or extracted) from training data may be changed to state information (e.g., an event number). For example, log patterns having different costs may be changed (or identified) as different state information. For example, log patterns having the same cost may be changed (or identified) as the same state information.

Each of the above-described plurality of log patterns may be stored in the memory. Therefore, the anomaly detector 450 may identify state information based on a log pattern identified based on log data corresponding to one of the plurality of log patterns stored in the memory. The anomaly detector 450 may identify an anomaly of the at least one NE 410 based on a log pattern identified based on log data not corresponding to one of the plurality of log patterns stored in the memory.

In the above-described embodiment, although an example in which state information is identified based on log data is illustrated, it is not limited thereto. The log data may represent information on operations over time. Therefore, first state information and second state information may be identified based on the log data.

As an example, the first state information may represent a state related to the at least one NE 410 at a first time point. The second state information may represent a state related to the at least one NE 410 at a second time point after the first time point. For example, the first state information may represent a past state of the at least one NE 410. The second state information may represent a current state of the at least one NE 410. For example, the first state information may include a first event number. The second state information may include a second event number. Each of the first event number and the second event number may be a value for indicating a state of the at least one NE 410.

FIG. 7 illustrates an example of an operation of a state model according to an embodiment of the disclosure.

Referring to FIG. 7, an anomaly detector 450 may identify state information (e.g., an event number) based on a log parser 460. The anomaly detector 450 may sequentially identify (or output) state information by using the log parser 460. By using a state model 471, the anomaly detector 450 may identify whether a state change is a normal change based on the sequentially identified state information. For example, the anomaly detector 450 may identify first state information and second state information by using the log parser 460. The anomaly detector 450 may input the first state information to the state model 471. The anomaly detector 450 may obtain third state information based on an output of the state model 471. The anomaly detector 450 may identify an anomaly of at least one NE 410 based on identifying that the second state information is distinct from the third state information. The anomaly detector 450 may identify a normal state of the at least one NE 410 based on identifying that the second state information corresponds to the third state information.

According to an embodiment, the state model 471 may be configured based on a finite state automata. The state model 471 is automata having a finite state, and the state model 471 may have one state at one time. Each state may be transitioned (or be changed) to another state according to a specific event. The state model 471 may be configured with a transition state and a set of conditions causing the transition state.

The state model 471 may include a set for state changes. For example, in a case that the at least one NE 410 operates normally, a q1 state has a possibility to be changed to a q139 state. The q139 state has a possibility to be changed to a q175 state. After the q1 state is identified, based on the q139 state being identified based on log data, the anomaly detector 450 may identify that the at least one NE 410 is in a normal state. After the q139 state is identified, based on the q175 state being identified based on log data, the anomaly detector 450 may identify that the at least one NE 410 is in an abnormal state. On the other hand, after the q139 state is identified, based on a q190 state being identified based on log data, the anomaly detector 450 may identify that the at least one NE 410 is in the abnormal state.

According to an embodiment, even in a case that a state change not included in the state model 471 occurs, when a state transition within two times is possible, the at least one NE 410 may be identified as being in the normal state. For example, a transition from a q2 state to a q19 state is not included in the state model 471, but in a case that the transition from the q2 state to the q19 state and a transition from the q19 state to a q150 state are possible, the at least one NE 410 may be identified as being in the normal state.

FIG. 8 illustrates an example of an operation of a prediction model according to an embodiment of the disclosure.

Referring to FIG. 8, an anomaly detector 450 may identify state information (e.g., an event number) based on a log parser 460. The anomaly detector 450 may sequentially identify (or output) state information by using the log parser 460. Based on the sequentially identified state information, the anomaly detector 450 may identify state information predicted by using a prediction model 472. The anomaly detector 450 may identify an anomaly of at least one NE 410 based on the predicted state information. For example, the anomaly detector 450 may identify first state information and second state information by using the log parser 460. The anomaly detector 450 may input the first state information to the prediction model 472. The anomaly detector 450 may obtain fourth state information based on an output of the prediction model 472. The anomaly detector 450 may identify the anomaly of the at least one NE 410 based on identifying that the second state information is distinct from the fourth state information. The anomaly detector 450 may identify a normal state of the at least one NE 410 based on identifying that the second state information corresponds to the fourth state information.

According to an embodiment, the prediction model 472 may be configured based on a long short term memory (LSTM). The prediction model 472 may include a first layer 801, a second layer 802, and a third layer 803.

An input of the first layer 801 may be configured with n states. The anomaly detector 450 may input consecutive n states to the prediction model 472. The n may be changed by an administrator (or a user). The first layer 801 may be referred to as an LSTM layer. The LSTM may be one of machine learning algorithms known to be most suitable for time series data analysis. In a case that data is sequentially input, the LSTM may have high performance for prediction of a next result (or flow).

The second layer 802 may be configured at an output end of the first layer 801. The second layer 802 may be referred to as a fully connected (FC) layer. In order to identify probability data of a plurality of states, the number of outputs of the second layer 802 may be set as k. The k may correspond to the number of state information identified in the log parser 460. A k-dimensional vector may be generated as an output of the second layer 802. The output of the second layer 802 may represent a probability that each of k states occurs.

In order for a total sum of probabilities at which each of k states occurs to become 1, the third layer 803 may be configured at an output end of the second layer 802. The third layer 803 may be referred to as a softmax layer. The anomaly detector 450 may obtain predicted state information based on a state having the highest probability by using the prediction model 472.

The anomaly detector 450 may identify the normal state of the at least one NE 410 based on identifying that state information identified based on log data corresponds to state information predicted through the prediction model 472. The anomaly detector 450 may identify the anomaly of the at least one NE 410 based on identifying that the state information identified based on the log data is distinct from the state information predicted through the prediction model 472.

According to an embodiment, the anomaly detector 450 may provide a notification (or an alarm) based on the prediction model 472 identifying an anomaly continuously by the designated number of times (e.g., 7 times).

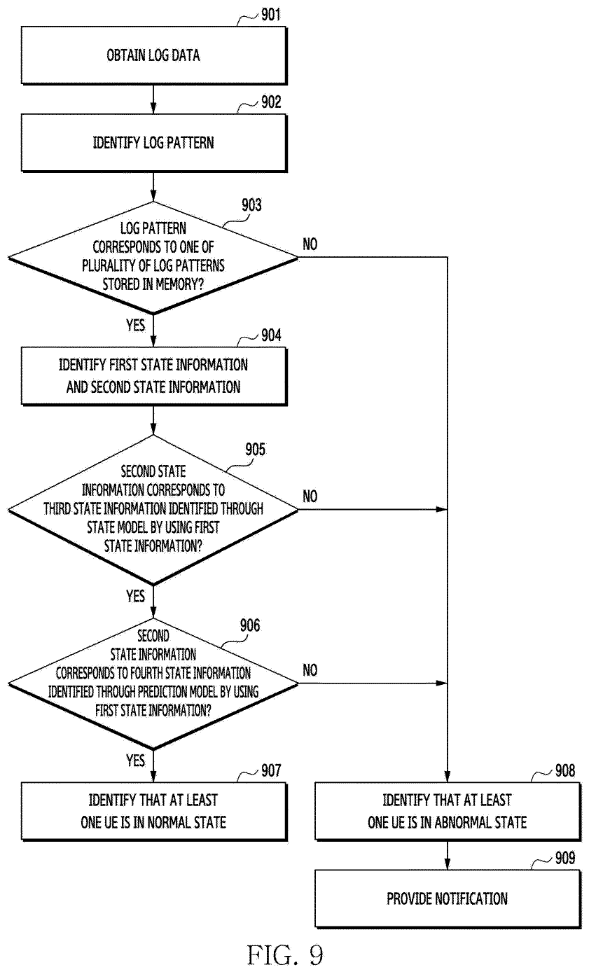

FIG. 9 illustrates a flowchart related to an operation of an anomaly detector according to an embodiment of the disclosure.

Referring to FIG. 9, in operation 901, an anomaly detector 450 (or an electronic device for the anomaly detector 450) may obtain log data. For example, the anomaly detector 450 may obtain log data from at least one NE 410.

In operation 902, the anomaly detector 450 may identify a log pattern. For example, the anomaly detector 450 may identify the log pattern based on the log data. The anomaly detector 450 may normalize the log data based on a designated algorithm (or a designated rule). The anomaly detector 450 may obtain the log pattern based on normalizing the log data.

In operation 903, the anomaly detector 450 may identify whether the log pattern corresponds to one of a plurality of log patterns stored in memory. The anomaly detector 450 may identify whether the log pattern identified based on the log data corresponds to one of the plurality of log patterns stored in the memory. Each of the plurality of log patterns stored in the memory may represent a normal state.

In operation 904, in a case that the log pattern corresponds to one of the plurality of log patterns stored in the memory, the anomaly detector 450 may identify first state information and second state information. Based on identifying that the log pattern corresponds to one of the plurality of log patterns stored in the memory, the anomaly detector 450 may identify the first state information and the second state information.

For example, the log data may include log messages (text) obtained within a designated time interval. The first state information may indicate a state related to the at least one NE 410 at a first time point. The second state information may indicate a state related to the at least one NE 410 at a second time point after the first time point. For example, the first state information may indicate a past state of the at least one NE 410. The second state information may indicate a current state of the at least one NE 410.

For example, the anomaly detector 450 may perform the operation 902 to the operation 904 by using the log parser 460 described in FIG. 6.

In operation 905, the anomaly detector 450 may identify whether the second state information corresponds to third state information identified through the state model 471 by using the first state information. The anomaly detector 450 may identify the third state information through the state model 471 by using the first state information. The anomaly detector 450 may identify whether the second state information corresponds to the third state information. For example, the state model 471 may be configured based on a finite state automata. The third state information may mean state information transitioned from the first state information.

For example, the anomaly detector 450 may perform the operation 905 by using the state model 471 described in FIG. 7.

In operation 906, in a case that the second state information corresponds to the third state information, the anomaly detector 450 may identify whether the second state information corresponds to fourth state information identified through a prediction model 472 by using the first state information. For example, based on identifying that the second state information corresponds to the third state information, the anomaly detector 450 may identify whether the second state information corresponds to the fourth state information identified through the prediction model 472 by using the first state information. The anomaly detector 450 may identify the fourth state information through the prediction model 472 by using the first state information. The anomaly detector 450 may identify whether the second state information corresponds to the fourth state information. For example, the prediction model 472 may be configured based on a long short term memory (LSTM). The fourth state information may mean state information predicted based on the first state information.

In a case that the second state information corresponds to the fourth state information, operation 907 may identify that the at least one NE 410 is in a normal state. For example, the anomaly detector 450 may identify that the at least one NE 410 is in the normal state based on identifying that the second state information corresponds to the fourth state information. The anomaly detector 450 may identify that the at least one NE 410 is in the normal state based on identifying that a condition of the operation 903, a condition of the operation 905, and a condition of the operation 906 are all satisfied.

In operation 908, in a case that at least one of the conditions of the operation 903, the condition of the operation 905, and the condition of the operation 906 is not satisfied, the anomaly detector 450 may identify that the at least one NE 410 is in an abnormal state (or an anomaly of the at least one NE 410). The anomaly detector 450 may identify that the at least one NE 410 is in the abnormal state based on identifying that at least one of the conditions of the operation 903, the condition of the operation 905, and the condition of the operation 906 is not satisfied.

In operation 909, the anomaly detector 450 may provide a notification (or an alarm) based on identifying that the at least one NE 410 is in the abnormal state. According to an embodiment, the anomaly detector 450 may provide a notification to a network controller 420. The network controller 420 may change a path of data traffic to bypass the at least one NE 410 in which the abnormal state has occurred.

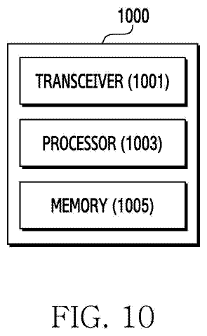

FIG. 10 illustrates an example of a functional configuration of an electronic device according to an embodiment of the disclosure.

Referring to FIG. 10, an electronic device 1000 may correspond to the anomaly detector 450 of FIGS. 4 to 9. According to an embodiment, the electronic device 1000 may include a transceiver 1001, a processor 1003, and memory 1005.

The transceiver 1001 may perform functions for transmitting and receiving a signal in a wired communication environment. The transceiver 1001 may include a wired interface for controlling a direct connection between a device and a device through a transmission medium (e.g., a copper wire or an optical fiber). For example, the transceiver 1001 may deliver an electrical signal to another device through a copper wire, or perform conversion between an electrical signal and an optical signal.

The transceiver 1001 may also perform functions for transmitting and receiving a signal in a wireless communication environment. For example, the transceiver 1001 may perform a function for conversion between a baseband signal and a bit string according to a physical layer standard of a system. For example, when transmitting data, the transceiver 1001 generates complex-valued symbols by encoding and modulating a transmission bit string. In addition, when receiving data, the transceiver 1001 restores a reception bit string by demodulating and decoding a baseband signal. In addition, the transceiver 1001 may include a plurality of transmission/reception paths.

The transceiver 1001 transmits and receives a signal as described above. Accordingly, all or a portion of the transceiver 1001 may be referred to as a ‘communication unit’, a ‘transmission unit’, a ‘reception unit’, or a ‘transceiver unit’. In addition, in the following description, transmission and reception performed through a wireless channel are used to mean including that processing as described above is performed by the transceiver 1001.

The processor 1003 controls overall operations of the electronic device 1000. The processor 1003 may be referred to as a control unit. For example, the processor 1003 transmits and receives a signal through the transceiver 1001. Also, the processor 1003 records and reads data in the memory 1005. Additionally, the processor 1003 may perform functions of a protocol stack required in a communication standard. Although only the processor 1003 is illustrated in FIG. 10, according to another implementation example, the electronic device 1000 may include two or more processors.

In the disclosure, operations of the processor 1003 may mean being executed by software, or controlling hardware components such as a field programmable gate array (FPGA) or an application-specific integrated circuit (ASIC). In addition, the processor 1003 may include at least one of components such as software components, object-oriented software components, class components, and task components, and processes, functions, attributes, procedures, subroutines, segments of program code, drivers, firmware, microcode, circuitry, data, a database, data structures, tables, arrays, and variables. The processor 1003 may include at least one module, and a term “module” includes a unit configured with hardware, software, or firmware. For example, a module may be interchangeably used with terms such as logic, a logic block, a component, or circuitry, and the like. A module may be an integrally configured component, or a minimum unit performing one or more functions, or a portion thereof. For example, a module may be configured as an ASIC.

For example, the processor 1003 may include at least a portion or all of blocks according to the above-described embodiments (e.g., the blocks illustrated in FIG. 4). The processor 1003 may perform functions of at least a portion or all of the blocks according to the above-described embodiments (e.g., the blocks illustrated in FIG. 4).

The memory 1005 stores data such as a basic program, an application program, setting information, and the like for an operation of the electronic device 1000. The memory 1005 may be referred to as a storage unit. The memory 1005 may be configured with a volatile memory, a non-volatile memory, or a combination of the volatile memory and the non-volatile memory. Additionally, the memory 1005 provides the stored data according to a request of the processor 1003.

According to an embodiment, an electronic device may comprise memory, comprising one or more storage media, storing instructions, and at least one processor comprising processing circuitry. The instructions, when executed by the at least one processor individually or collectively, may cause the electronic device to obtain, from at least one network element (NE), log data related to an operation of the at least one NE. The instructions, when executed by the at least one processor individually or collectively, may cause the electronic device to, based on the log data, obtain, through a designated algorithm, a log pattern. The instructions, when executed by the at least one processor individually or collectively, may cause the electronic device to, based on the log pattern, identify first state information and second state information. The instructions, when executed by the at least one processor individually or collectively, may cause the electronic device to identify that the second state information is distinct from state information identified through at least one model using the first state information. The instructions, when executed by the at least one processor individually or collectively, may cause the electronic device to, based on identifying that the second state information is distinct from the state information identified through the at least one model, identify an anomaly of the at least one NE.

According to an embodiment, the instructions, when executed by the at least one processor individually or collectively, may cause the electronic device to normalize the log data based on the designated algorithm. The instructions, when executed by the at least one processor individually or collectively, may cause the electronic device to, based on normalizing the log data, obtain the log pattern.

According to an embodiment, the instructions, when executed by the at least one processor individually or collectively, may cause the electronic device to identify whether the log pattern corresponds to one of a plurality of log patterns stored in the memory. The instructions, when executed by the at least one processor individually or collectively, may cause the electronic device to identify, in a case that the log pattern corresponds to one of the plurality of log patterns, identify, based on the log pattern, the first state information and the second state information. The instructions, when executed by the at least one processor individually or collectively, may cause the electronic device to, in a case that the log pattern does not correspond to one of the plurality of log patterns, identify the anomaly of the at least one NE.

According to an embodiment, the at least one model may comprise a state model and a prediction model.

According to an embodiment, the instructions, when executed by the at least one processor individually or collectively, may cause the electronic device to identify that the second state information is distinct from third state information identified through the state model. The instructions, when executed by the at least one processor individually or collectively, may cause the electronic device to, based on identifying that the second state information is distinct from third state information, identify the anomaly of the at least one NE.

According to an embodiment, the instructions, when executed by the at least one processor individually or collectively, may cause the electronic device to input the first state information to the state model. The instructions, when executed by the at least one processor individually or collectively, may cause the electronic device to, based on an output of the state model, obtain the third state information.

According to an embodiment, the instructions, when executed by the at least one processor individually or collectively, may cause the electronic device to, based on identifying that the second state information corresponds to the third state information, identify that the second state information is distinct from fourth state information identified through the prediction model. The instructions, when executed by the at least one processor individually or collectively, may cause the electronic device to, based on identifying that the second state information is distinct from the fourth state information, identify the anomaly of the at least one NE.

According to an embodiment, the instructions, when executed by the at least one processor individually or collectively, may cause the electronic device to input the first state information to the prediction model. The instructions, when executed by the at least one processor individually or collectively, may cause the electronic device to, based on an output of the prediction model, obtain the fourth state information.

According to an embodiment, the instructions, when executed by the at least one processor individually or collectively, may cause the electronic device to identify, based on the output of the prediction model, probability data related to each of a plurality of states. The instructions, when executed by the at least one processor individually or collectively, may cause the electronic device to obtain the fourth state information based on a state with a highest probability among the plurality of states.

According to an embodiment, the state model may be configured based on a finite state automata. The prediction model may be configured based on a long short term memory (LSTM).

According to an embodiment, a method performed by an electronic device may comprise obtaining, from at least one network element (NE), log data related to an operation of the at least one NE. The method may comprise, based on the log data, obtaining, through a designated algorithm, a log pattern. The method may comprise, based on the log pattern, identifying first state information and second state information. The method may comprise identifying that the second state information is distinct from state information identified through at least one model using the first state information. The method may comprise, based on identifying that the second state information is distinct from the state information identified through the at least one model, identifying an anomaly of the at least one NE.

According to an embodiment, the method may comprise normalizing the log data based on the designated algorithm. The method may comprise, based on normalizing the log data, obtaining the log pattern.

According to an embodiment, the method may comprise identifying whether the log pattern corresponds to one of a plurality of log patterns stored in a memory of the electronic device. The method may comprise, in a case that the log pattern corresponds to one of the plurality of log patterns, identifying, based on the log pattern, the first state information and the second state information. The method may comprise, in a case that the log pattern does not correspond to one of the plurality of log patterns, identifying the anomaly of the at least one NE.

According to an embodiment, the at least one model may comprise a state model and a prediction model.

According to an embodiment, the method may comprise identifying that the second state information is distinct from third state information identified through the state model. The method may comprise, based on identifying that the second state information is distinct from third state information, identifying the anomaly of the at least one NE.

According to an embodiment, the method may comprise inputting the first state information to the state model. The method may comprise, based on an output of the state model, obtaining the third state information.

According to an embodiment, the method may comprise, based on identifying that the second state information corresponds to the third state information, identifying that the second state information is distinct from fourth state information identified through the prediction model. The method may comprise, based on identifying that the second state information is distinct from the fourth state information, identifying the anomaly of the at least one NE.

According to an embodiment, the method may comprise inputting the first state information to the prediction model. The method may comprise, based on an output of the prediction model, obtaining the fourth state information.

According to an embodiment, the method may comprise identifying, based on the output of the prediction model, probability data related to each of a plurality of states. The method may comprise obtaining the fourth state information based on a state with a highest probability among the plurality of states.

According to an embodiment, the state model may be configured based on a finite state automata. The prediction model may be configured based on a long short term memory (LSTM).

According to the above-described embodiment, an anomaly may be identified (or detected) in real time through a network equipment (or an NE). For example, as a similar log pattern is analyzed based on log data, the log data may be effectively compressed. By training a log pattern while the network equipment is in a normal state, an abnormal log of the network equipment may be determined in real time. In a case that an anomaly of the network equipment is identified, a notification may be provided to a network administrator to check whether an actual anomaly exists. Accordingly, since a notification for the anomaly is provided first, occurrence of a critical problem may be prevented. Conventionally, it was difficult to identify an anomaly since log contents for a network protocol and log contents reflecting a characteristic of the network equipment were not considered, but according to the above-described embodiment, since a state of the network equipment is learned through log data output from the network equipment, there is an effect that an anomaly is accurately detected.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, an optical storage device (e.g., a compact disc-ROM (CD-ROM), digital versatile discs (DVDs), or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
at least one processor comprising processing circuitry,
wherein the instructions, when executed by the at least one processor individually or collectively, cause the electronic device to:
obtain, from at least one network element (NE), log data related to an operation of the at least one NE,
based on the log data, obtain, through a designated algorithm, a log pattern,
based on the log pattern, identify first state information and second state information,
identify that the second state information is distinct from state information identified through at least one model using the first state information, and
based on identifying that the second state information is distinct from the state information identified through the at least one model, identify an anomaly of the at least one NE.

2. The electronic device of claim 1, wherein the instructions, when executed by the at least one processor individually or collectively, further cause the electronic device to:
normalize the log data based on the designated algorithm, and
based on normalizing the log data, obtain the log pattern.

3. The electronic device of claim 1, wherein the instructions, when executed by the at least one processor individually or collectively, further cause the electronic device to:
identify whether the log pattern corresponds to one of a plurality of log patterns stored in the memory,
in a case that the log pattern corresponds to one of the plurality of log patterns, identify, based on the log pattern, the first state information and the second state information, and
in a case that the log pattern does not correspond to one of the plurality of log patterns, identify the anomaly of the at least one NE.

4. The electronic device of claim 1, wherein the at least one model comprises a state model and a prediction model.

5. The electronic device of claim 4, wherein the instructions, when executed by the at least one processor individually or collectively, further cause the electronic device to:
identify that the second state information is distinct from third state information identified through the state model, and
based on identifying that the second state information is distinct from third state information, identify the anomaly of the at least one NE.

6. The electronic device of claim 5, wherein the instructions, when executed by the at least one processor individually or collectively, further cause the electronic device to:
input the first state information to the state model, and
based on an output of the state model, obtain the third state information.

7. The electronic device of claim 5, wherein the instructions, when executed by the at least one processor individually or collectively, further cause the electronic device to:
based on identifying that the second state information corresponds to the third state information, identify that the second state information is distinct from fourth state information identified through the prediction model, and
based on identifying that the second state information is distinct from the fourth state information, identify the anomaly of the at least one NE.

8. The electronic device of claim 7, wherein the instructions, when executed by the at least one processor individually or collectively, cause the electronic device to:
input the first state information to the prediction model, and
based on an output of the prediction model, obtain the fourth state information.

9. The electronic device of claim 8, wherein the instructions, when executed by the at least one processor individually or collectively, cause the electronic device to:
identify, based on the output of the prediction model, probability data related to each of a plurality of states, and
obtain the fourth state information based on a state with a highest probability among the plurality of states.

10. The electronic device of claim 4,
wherein the state model is configured based on a finite state automata, and
wherein the prediction model is configured based on a long short term memory (LSTM).

11. A method performed by an electronic device, the method comprising:
obtaining, from at least one network element (NE), log data related to an operation of the at least one NE;
based on the log data, obtaining, through a designated algorithm, a log pattern;
based on the log pattern, identifying first state information and second state information;
identifying that the second state information is distinct from state information identified through at least one model using the first state information; and
based on identifying that the second state information is distinct from the state information identified through the at least one model, identifying an anomaly of the at least one NE.

12. The method of claim 11, further comprising:
normalizing the log data based on the designated algorithm; and
based on normalizing the log data, obtaining the log pattern.

13. The method of claim 11, further comprising:
identifying whether the log pattern corresponds to one of a plurality of log patterns stored in memory of the electronic device;
in a case that the log pattern corresponds to one of the plurality of log patterns, identifying, based on the log pattern, the first state information and the second state information; and
in a case that the log pattern does not correspond to one of the plurality of log patterns, identifying the anomaly of the at least one NE.

14. The method of claim 11, wherein the at least one model comprises a state model and a prediction model.

15. The method of claim 14, further comprising:
identifying that the second state information is distinct from third state information identified through the state model; and
based on identifying that the second state information is distinct from third state information, identifying the anomaly of the at least one NE.

16. The method of claim 15, further comprising:
inputting the first state information to the state model; and
based on an output of the state model, obtaining the third state information.

17. The method of claim 15, further comprising:
based on identifying that the second state information corresponds to the third state information, identifying that the second state information is distinct from fourth state information identified through the prediction model; and
based on identifying that the second state information is distinct from the fourth state information, identifying the anomaly of the at least one NE.

18. The method of claim 17, further comprising:
inputting the first state information to the prediction model; and
based on an output of the prediction model, obtaining the fourth state information.

19. The method of claim 18, further comprising:
identifying, based on the output of the prediction model, probability data related to each of a plurality of states; and
obtaining the fourth state information based on a state with a highest probability among the plurality of states.

20. The method of claim 14,
wherein the state model is configured based on a finite state automata, and
wherein the prediction model is configured based on a long short term memory (LSTM).
